(19) United States
(12) Patent Application Publication
(10) Pub. No.: US 2006/0289517 A1
(43) Pub. Date: Dec. 28, 2006

(54) Microwave platform for generating marks on food products and method of using same

(76) Inventor: Rolland Lorbach, Hudson, OH (US)

Correspondence Address: BELL, BOYD & LLOYD LLC, P. O. BOX 1135, CHICAGO, IL, 60690-1135, US

(21) Appl. No.: 11/146,833

(22) Filed: Jun. 6, 2005

(51) Int. Cl. H05B 6/80

(52) U.S. Cl. 219/730

(57) ABSTRACT

Microwave platforms for generating marks on microwavable food products are presented. In an embodiment, the microwave platform comprises a microwave susceptor and a corrugated tubular member having flutes for containing insulated air, the tubular member attached to the microwave susceptor to form the microwave platform, wherein the microwave platform defines a plurality of slits and wherein the microwave platform is capable of causing grill marks to be formed on a food product when the food product is microwaved.

### BACKGROUND OF THE INVENTION

The present invention relates generally to food technologies. More specifically, the present invention relates to microwave platforms for producing food products and methods of using same.

Markings such as grill marks give food a cooked appearance that consumers enjoy. Typically, grill marks on food products are associated with outdoor gas or charcoal grills when various food products such as meat and vegetables are cooked on a rack over a heat source. As one portion of the food is cooked more or less than another section of the food due to the rack, grill marks develop to distinguish the two sections. In a similar manner, indoor ovens or stoves may also be used to generate grill marks in food with the proper cookware.

Due to convenience and a reduction in time for food preparation, many people use microwave ovens to cook food products. Microwave ovens use microwaves (e.g. radio waves) to heat food. These radio waves are within a frequency range that causes them to be absorbed by molecules of water, fats and sugars in foods. These molecules become excited and give off heat. In microwave cooking, the radio waves penetrate the food and excite water and fat molecules pretty evenly throughout the food. Unlike conventional ovens and grills, there is heat everywhere all at once because the molecules are all excited together, and with some exceptions, foods cook quickly and evenly in microwave ovens. Unfortunately, consumers are not able to achieve similar aesthetically pleasing grill marks while using a microwave oven to cook food products.

It is therefore desirable to improve the aesthetic appearance of microwavable food products.

### SUMMARY OF THE INVENTION

The present invention generally relates to the preparation of food. More specifically, the present invention relates to technologies that improve the aesthetic appearance of food, for example, the generation of grill marks on a microwavable food product.

In an embodiment, the present invention provides a microwave platform for generating grill marks on a microwavable food product, the microwave platform comprising a microwave susceptor, wherein the microwave susceptor defines at least one opening and wherein the microwave susceptor is capable of causing marks to be formed on the product when the product is microwaved.

In an embodiment, the microwave platform further comprises a base member attached to the microwave susceptor.

In an embodiment, the base member comprises a corrugated tubular member having flutes.

In an embodiment, the flutes comprise sinuous fluting.

In an embodiment, the microwave platform defines a plurality of slits.

In an embodiment, the slits have a width ranging between about 1/16 to about ¼ inch.

In an embodiment, the slits have a shape selected from the group consisting of straight, serpentine and combinations thereof.

In an embodiment, microwave platform has a height ranging between about 1/16 to about ½ inch.

In an embodiment, microwavable product is a dough-based product.

In an embodiment, the microwave platform has a shape selected from the group consisting of round, oval, polygon and combinations thereof.

In an embodiment, the microwave platform has a round shape with a diameter ranging between about 5 to about 12 inches.

In another embodiment, the present invention provides a microwave platform comprising a microwave susceptor and a corrugated tubular member having flutes for containing insulated air, the tubular member attached to the microwave susceptor to form the microwave platform, wherein the microwave platform defines a plurality of slits and wherein the microwave platform is capable of causing grill marks to be formed on the dough-based product when the dough-based product is microwaved.

In another embodiment, the present invention provides a method comprising: providing a microwave platform comprising a microwave susceptor and a base member attached to the microwave susceptor to form the microwave platform, wherein the microwave platform defines at least one opening; placing the microwavable product on the microwave platform; and microwaving the microwavable product at a sufficient power and time to generate marks on the microwavable product.

An advantage of the present invention is to improve the aesthetic appearance of microwavable food.

Another advantage of the present invention is to provide grill marks in microwavable food, especially dough-based products

Still another advantage of the present invention is to improve the overall quality of microwavable food.

Additional features and advantages of the present invention are described in, and will be apparent from, the following Detailed Description of the Invention and the figures.

### BRIEF DESCRIPTION OF THE FIGURES

FIG. 1 is a perspective view of the microwave platform in one embodiment of the present invention.

FIG. 2 is a top or plan view of the microwave platform in one embodiment of the present invention.

FIG. 3 is a bottom view of the microwave platform in one embodiment of the present invention.

FIG. 4 is a photograph of a food product having grill marks generated by using the microwave platform in one embodiment of the present invention.

FIG. 5 is a top or plan of the microwave platform in one embodiment of the present invention.

### DETAILED DESCRIPTION OF THE INVENTION

The present invention generally relates to food technologies that improve the aesthetic appearance of food. More specifically, the present invention relates to microwave platforms for generating marks, for example, such as grill marks on food products and method of using same.

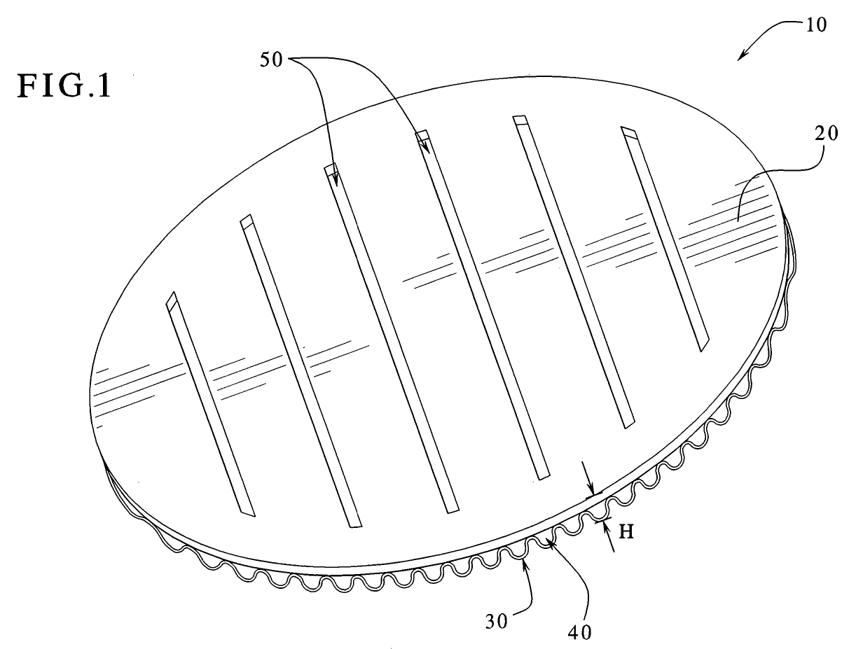

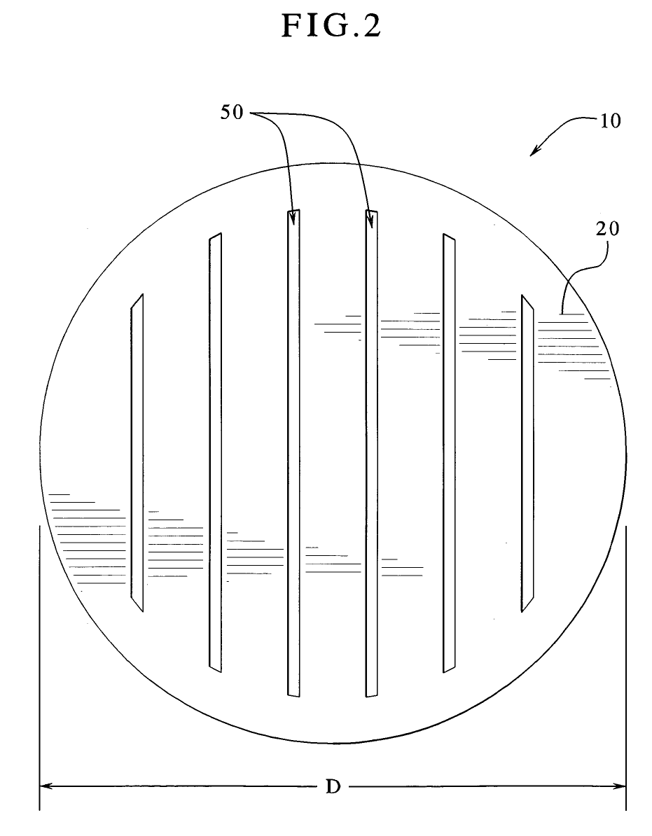

As illustrated in FIGS. 1-3, in an embodiment, the microwave platform 10 comprises a microwave susceptor 20, wherein the microwave susceptor 20 defines at least one opening and wherein the microwave susceptor 20 is capable of causing marks to be formed on the product when the product is microwaved. It should be appreciated that the susceptor 20 can be any suitable patch, film, or plate used with microwaveable food products in which radiant energy produced in the film or plate by microwaves helps cook the food, for example, by browning its surface.

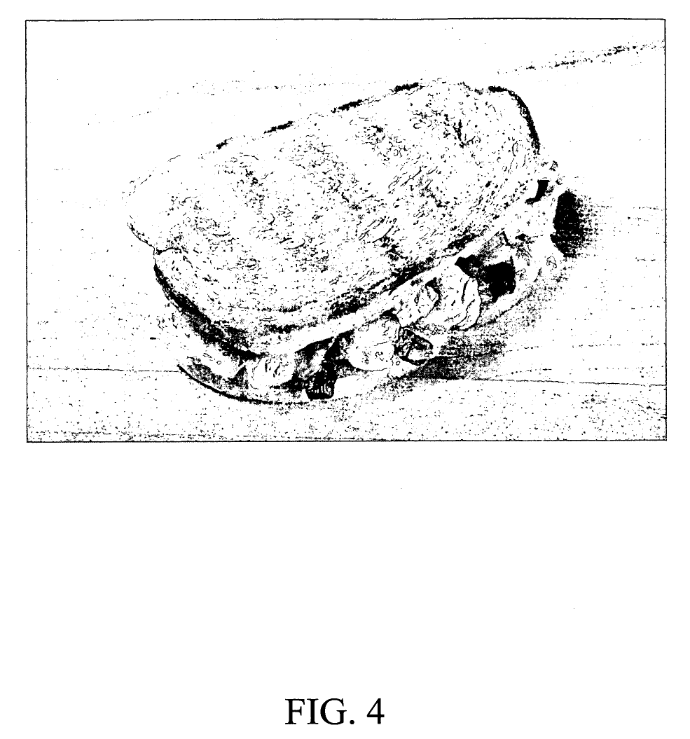

The microwave susceptor 20 can be, for example, a metalized film that attracts microwave energy and transmits waves into heat which causes food product touching the susceptor 20 to cook more rapidly than the product not touching the susceptor 20. This may result in microwaved food products that are crisper and darker in the areas touching the susceptor 20 and lighter in the areas not contacting the susceptor 20 (i.e. the product part over the susceptor opening). Thus, the microwave susceptor 20 can generate grill marks on food products, especially dough-based products such as bread as illustrated in FIG. 4. The food product can be microwaved on the platform 10 for any time suitable to generate a visible mark on the product.

In an embodiment, the microwave susceptor 20 may comprise a 48 gauge metalized (aluminum) Polyester film with an optical density of 0.26+/−0.03. The metalized film of the susceptor 20, for example, may be laminated to a 10 point or higher (thickness) paperboard or cup stock.

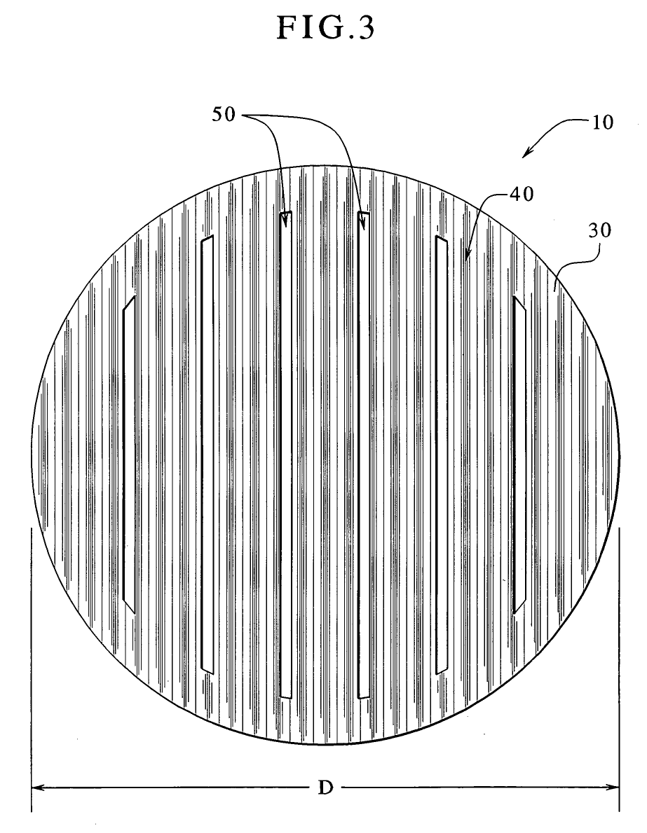

In an embodiment illustrated in FIGS. 1 and 3, the microwave platform 10 further comprises a base member 30 attached to the microwave susceptor 20 to form the microwave platform 10. The base member 30 may serve to separate the susceptor 20 from the microwave floor or tray. Thus, the base member 30 may allow the susceptor 20 to be heated more efficiently from microwaves above and below the susceptor 20. The base member 30 may also serve as an insulator to prevent heat conduction from the susceptor 20 to the microwave floor or tray thereby reducing the heating efficiency of the susceptor 20. The base member 30 may comprise any material suitable for these purposes.

The base member 30 can comprise, for example, a corrugated tubular member 30 having flutes 40 for containing insulated air. The flutes 40 may comprise sinuous fluting or any suitable shape.

The susceptor 20 may be laminated or attached by adhesive to the corrugated medium 30 which can be, for example, a 17 lb Bleached (or unbleached) Kraft, B-flute. A, B, C, E and F flute can be used depending on the desired elevation of the platform.

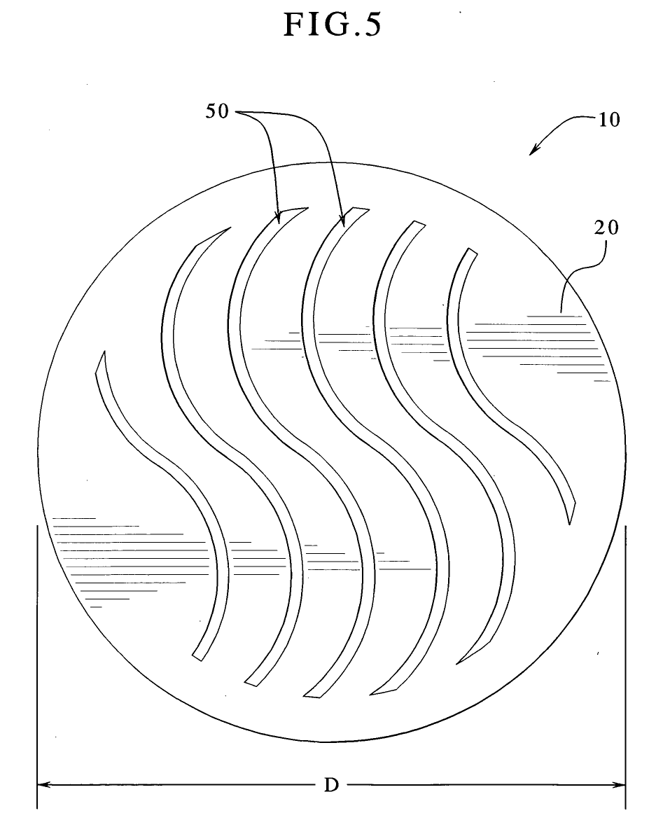

As illustrated in FIGS. 1, in an embodiment, the microwave platform 10 defines a plurality of slits 50. It should be appreciated that the slits 50 may have any suitable shape, length and width to produce a desirable mark on the microwavable food product. Preferably, the slits 50 have a straight shape (illustrated in FIGS. 1-3), serpentine shape (illustrated in FIG. 5) or combinations thereof. Preferably, the slits 50 have a width ranging between about 1/16 to about ¼ inch. Although FIG. 1 shows the slits running parallel to the flute direction, it should be appreciated that the slits can be perpendicular to the flutes or in any suitable orientation with respect to the flutes.

The microwave platform 10 may include one or more additional bases or supports above or beneath the base member 30 to provide structure support, height and/or rigidity to the microwave platform 10. The additional bases may be made of any suitable shape and material for their intended purposes.

The microwave platform 10 may also have any suitable height H for use in a microwave. Preferably, the microwave platform 10 has a height ranging between about 1/16 to about ½ inch.

The microwave platform 10 may have any suitable shape for use in a microwave. For example, the microwave platform 10 may have a round shape or oval shape. The microwave platform 10 may also have a polygon shape such as a triangle, square or rectangle.

The microwave platform 10 may have any suitable length for use in a microwave. Preferably, the microwave has a round or square shape with a diameter D or length, respectively, ranging between about 5 to about 12 inches.

In an alternative embodiment for generating marks on a microwavable product, the present invention provides a method comprising: providing a microwave platform 10 comprising a microwave susceptor 20, wherein the microwave platform 10 defines at least one opening; placing the microwavable product on the microwave platform 10; and microwaving the microwavable product at a sufficient power and time to generate marks on the microwavable product. In an embodiment of the method, the microwave susceptor 20 may include a base member 30 attached to the microwave susceptor 20 to form the microwave platform 10

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A microwave platform for generating marks on a microwavable product, the microwave platform comprising a microwave susceptor and a base member attached to the microwave susceptor, wherein the microwave susceptor defines at least one opening and wherein the microwave susceptor so constructed and arranged for causing marks to be formed on the product when the product is microwaved.

2. (canceled)

3. The microwave platform of claim 1, wherein the base member comprises a corrugated tubular member having flutes.

4. The microwave platform of claim 3, wherein the flutes comprise sinuous fluting.

5. The microwave platform of claim 1, wherein the microwave platform defines a plurality of slits.

6. The microwave platform of claim 5, wherein the slits have a width ranging between about 1/16 to about ¼ inch.

7. The microwave platform of claim 6, wherein the slits have a shape selected from the group consisting of straight, serpentine and combinations thereof.

8. The microwave platform of claim 1, wherein microwave platform has a height ranging between about 1/16 to about ½ inch.

9. The microwave platform of claim 1, wherein the microwave platform has a shape selected from the group consisting of round, oval, polygon and combinations thereof.

10. The microwave platform of claim 1, wherein the microwave platform has a round shape with a diameter ranging between about 5 to about 12 inches.

11. A microwave platform for generating grill marks on a microwavable dough-based product, the microwave platform comprising a microwave susceptor and a corrugated tubular member having flutes for containing insulated air, the tubular member attached to the microwave susceptor to form the microwave platform, wherein the microwave platform defines a plurality of slits and wherein the microwave platform is so constructed and arranged for causing grill marks to be formed on the dough-based product when the dough-based product is microwaved.

12. The microwave platform of claim 11, wherein the slits have a width ranging between about 1 to about 5 cm.

13. The microwave platform of claim 12, wherein the slits have a shape selected from the group consisting of straight, serpentine and combinations thereof.

14. The microwave platform of claim 11, wherein the microwave platform has a shape selected from the group consisting of round, oval, polygon and combinations thereof.

15. The microwave platform of claim 11, wherein the flutes comprise sinuous fluting.

16. A method for generating marks on a microwavable product, the method comprising:
providing a microwave platform comprising a microwave susceptor and a base member attached to the microwave susceptor, wherein the microwave platform defines at least one opening;
placing the microwavable product on the microwave platform; and
microwaving the microwavable product at a sufficient power and time to generate marks on the microwavable product.

17. The method of claim 16, wherein the base member comprises a corrugated tubular member having flutes for containing insulated air.

18. The method of claim 16, wherein the microwave platform defines a plurality of slits having a width ranging between about 1-5 cm.

19. The method of claim 18, wherein the slits have a shape selected from the group consisting of straight, serpentine and combinations thereof.

20. The method of claim 16, wherein microwavable product is a dough-based product.
